(19) United States
(12) Patent Application Publication
(10) Pub. No.: US 2013/0017868 A1
(43) Pub. Date: Jan. 17, 2013

(54) Hands-Free Telephone Headset Accessory

(71) Applicants: Jeremy Portwood, Austin, TX (US); Nicole Portwood, Austin, TX (US); Joe Poindexter, Waelder, TX (US); Deborah Poindexter, Waelder, TX (US)

(72) Inventors: Jeremy Portwood, Austin, TX (US); Nicole Portwood, Austin, TX (US); Joe Poindexter, Waelder, TX (US); Deborah Poindexter, Waelder, TX (US)

(21) Appl. No.: 13/179,820

(22) Filed: Jul. 11, 2011

(51) Int. Cl. H04W 88/00; H01F 7/00; F16B 47/00; F16B 2/08; A44B 18/00

(52) U.S. Cl. 455/569.1; 24/457; 24/306; 24/304; 24/303

(57) ABSTRACT

An accessory having a decorative item is removably secured to a hands-free telephone headset. Generally, the accessory permits a user to detachably connect a decorative item to the headset in a manner that does not impede the ease and comfort associated with the headset usage. An unlimited range and variety of decorative items may be provided, and such decorative items are preferably interchangeable, thereby providing the user with tremendous freedom in selecting a decorative item consistent with his/her mood and surroundings. Thus, the accessory permits customization and/or personalization of a user's headset in a non-permanent and convenient manner.

### BACKGROUND OF THE INVENTION

1. Field of the Invention

The present invention relates to an accessory that secures a decorative item to a hands-free telephone headset.

2. Related Art

Mobile (cellular) phone headsets are most often referred to as hands-free telephone headsets. Most mobile phones come with their own hands-free device in the form of a single earphone with a microphone module connected in the cable. For music-playing mobile phones, manufacturers will bundle stereo earphones with a microphone. High quality mobile headsets come in a range of wearing-styles, including behind-the-neck, over-the-head, over-the-ear, and lightweight earbuds.

Wireless mobile phone headsets are quickly becoming a new trend for both business and consumer communications. As for wireless mobile phone headsets, many of them now use Bluetooth® technology, as a growing number of mobile phones come with a Bluetooth® transceiver. Since more and more mobile phones come equipped with Bluetooth®, this technology has become a common wireless profile for wireless mobile phone headsets.

Standard Bluetooth® headsets are often a single-side monaural earpiece, which access the headset/handsfree profile of Bluetooth®. Depending on the phone's operating system, this type of headset may or may not play music.

Consumers are often interested in personalizing the items that they use on a frequent basis. This is done for several reasons including the ability to quickly identify their item when mixed with other similar items. Additionally, consumers often identify with a specific sport's team, colors, logos, and/or designs and decorate their personal items to show this preference. However, despite the prevalence of wireless mobile phone headsets, little has been done to personalize exterior aspects of the headset.

### SUMMARY OF THE INVENTION

According to the present disclosure, a removable accessory including a decorative item may be secured to a hands-free telephone headset. The accessory includes an attachment area integrally connected to a split loop strap having a first loop and a second loop of sufficient size to be coupled around the hands-free telephone headset to detachably secure the accessory to the hands-free telephone headset. In a preferred embodiment, the decorative item is also removable from the accessory in order to interchange decorative items.

### BRIEF DESCRIPTION OF THE SEVERAL VIEWS OF THE DRAWING(S)

The features and advantages of the present invention will become apparent from the following detailed description of a preferred embodiment thereof, taken in conjunction with the accompanying drawings, in which:

FIG. 1 is a plan view of the accessory 2 in accordance with one embodiment of the present invention;

FIG. 2 is a front view of the accessory 2 in accordance with one embodiment of the present invention showing the attachment area 4 provided in a plane substantially transverse to the side-by-side planes of the first loop 6 and second loop 8;

FIG. 3 is a side view of the accessory 2 in accordance with one embodiment of the present invention;

FIG. 4 is a bottom view of the accessory 2 in accordance with one embodiment of the present invention;

FIG. 5 is an underside view of an oval decorative item 20 having a post 22 in accordance with one embodiment of the present invention;

FIG. 6 is a top view of the oval decorative item 20 in accordance with one embodiment of the present invention;

FIG. 7 is an underside view of a flag-shaped decorative item 26 having a post 28 in accordance with one embodiment of the present invention;

FIG. 8 is a top view of the flag-shaped decorative item 26 in accordance with one embodiment of the present invention;

FIG. 9 shows the accessory 2 connected to a hands-free telephone headset in accordance with one embodiment of the present invention;

FIG. 10 shows the flag-shaped decorative item 26 connected to the accessory 2 and detachably secured to the head set body 32 of heads-free telephone headset 30 in accordance with one embodiment of the present invention.

### DETAILED DESCRIPTION OF THE INVENTION

The present disclosure is directed to an accessory having a decorative item that may be used with any hands-free telephone headset. Generally, the accessory permits a user to detachably secure a decorative item to the hands-free telephone headset in a manner that does not impede the ease and comfort associated with the hands-free telephone headset usage. An unlimited range and variety of decorative items may be provided, and such decorative items are preferably interchangeable, thereby providing the user with tremendous freedom in selecting a decorative item consistent with his/her mood and surroundings. Thus, the present disclosure permits customization and/or personalization of a user's hands-free telephone headset in a non-permanent and convenient manner.

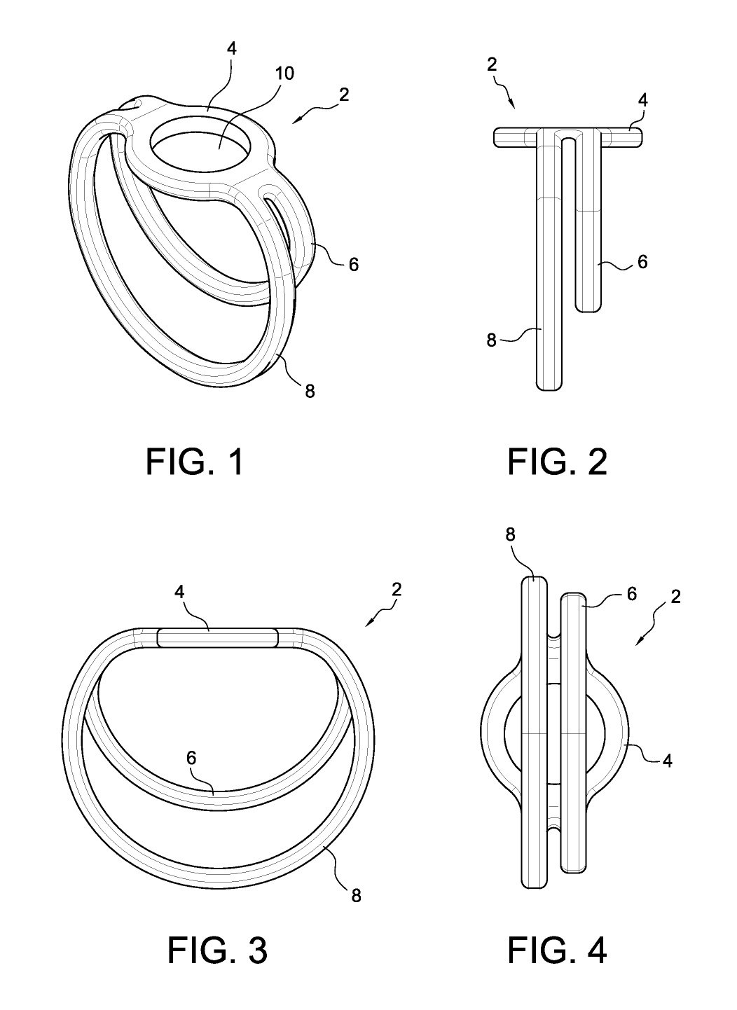

The accessory 2 includes an attachment area 4 integral with a split loop strap having a first loop 6 and a second loop 8. In one embodiment, the first loop 6 may be a smaller loop having a small diameter that is less than the diameter of the second loop 8. In one embodiment, the first loop 6 and the second loop 8 are arranged such that they are positioned side-by-side to one another in a plane substantially transverse to a plane of the attachment area 4. In one embodiment, the decorative item may be permanently affixed to the accessory 2 at the attachment area 4. However, FIGS. 1-4 show another embodiment of the accessory 2 wherein the decorative item is removably connected to the accessory 2 at the attachment area 4. In this embodiment, the attachment area 4 includes a socket 10 for receiving a corresponding post from a decorative item. The attachment area may include any attachment mechanism known to those of skill in the art which enable two devices to be joined, including, but not limited to, hook-and-loop fasteners (Velcro®), posts, pins, adhesives, magnetic tape, two-sided tape, and the like.

The accessory 2 may be formed from any suitable material. In one embodiment, the accessory is formed from rubber, such as injection molded vulcanized natural polyisoprene rubber having an elongation before break of greater than 400%. The accessory 2 may include an attachment area 4, a first loop 6 and a second loop 8 formed from the same material or the attachment area 4 may be formed from a different material than the first loop 6 and second loop 8. In one embodiment, the attachment area 4 may be fabricated from a rigid material and the first loop 6 and second loop 8 may be formed from flexible material.

The size and dimensions of the attachment area 4, first loop 6, and second loop 8 are of sufficient size such that the first loop 6 and second loop 8 can be coupled around the hands-free telephone headset to detachably secure the accessory 2 to the hands-free telephone headset. In one embodiment, the attachment area 4 is less than one inch, and preferably less than 0.5 inch. In one embodiment, the first loop 6 has a diameter that is less than one inch, and preferably less than 0.5 inch. In one embodiment, the second loop 8 has a diameter that is less than one inch, and preferably less than 0.7 inch. As will be appreciated by one of skill in the art, the precise geometry, dimensional properties, and aesthetic appearance of the accessory 2 is not limited beyond the structural aspects just describe.

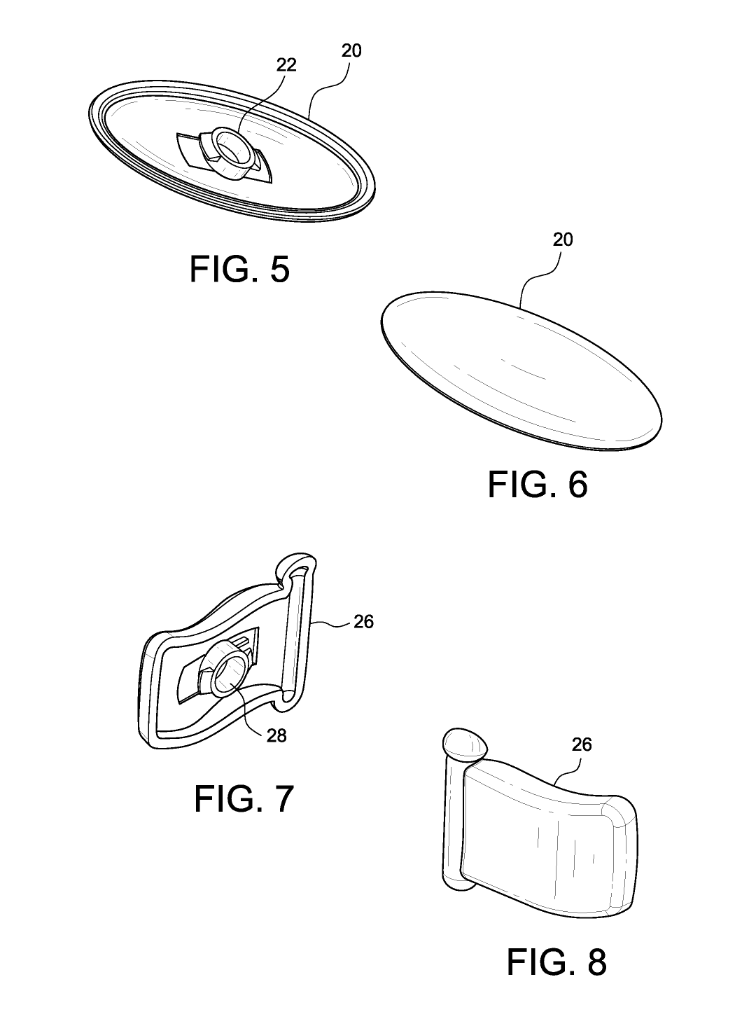

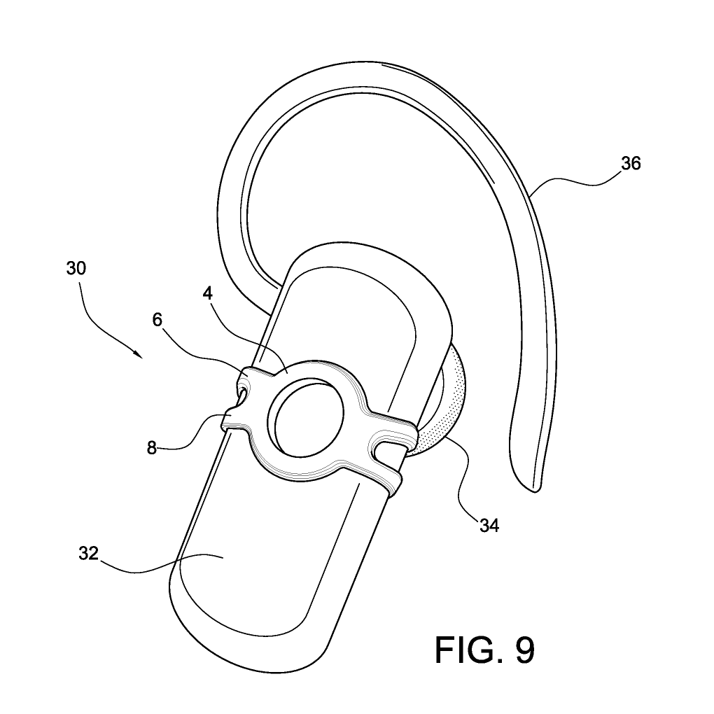

The decorative item may be fabricated from a variety of material, e.g., vinyl, plush, fabric, molded plastic, and the like. In one embodiment, the decorative item is fabricated from polycarbonate. Examples of contemplated decorative items include animals, cartoon characters, sports-related items, newsmakers, mechanical items, seasonal items, and abstract items. Decorative items that may be used as part of the accessory may include light, sound and/or interactive features, e.g. blinking lights, voice and/or sound generation functionality, motorized movement, and the like. Such light, sound and/or interactive features may be controlled by manual switches associated with the item, or through remote actuation. FIGS. 5-8 show a few embodiments of contemplated decorative items 20, 26. The examples provided in FIGS. 5-8 are illustrative in nature and are not meant to limit the scope of the decorative items contemplated by the present disclosure. FIG. 5 shows the underside of an oval decorative item 20 having a post 22 that may be connected to a socket provided in the accessory 2 in accordance with the present disclosure. FIG. 6 shows the top view of the oval decorative item 20. FIG. 7 shows the underside of a flag-shaped decorative item 26 having a post 28 that may be connected to a socket provided in the accessory 2 in accordance with the present disclosure. FIG. 8 shows the top view of the flag-shaped decorative item 26. The posts 22, 28 may be fabricated from any known material, including, but not limited to, plastic, metal, wood and the like. In one embodiment, the posts 22, 28 are formed from polycarbonate. Although the examples provided in FIGS. 5-8 show posts 22, 28 for attaching the decorative item to the accessory, the decorative items may be attached to the accessory using any known attachment mechanism, including, but not limited to, hook-and-loop fasteners (Velcro®), posts, pins, adhesives, magnetic tape, two-sided tape, and the like.

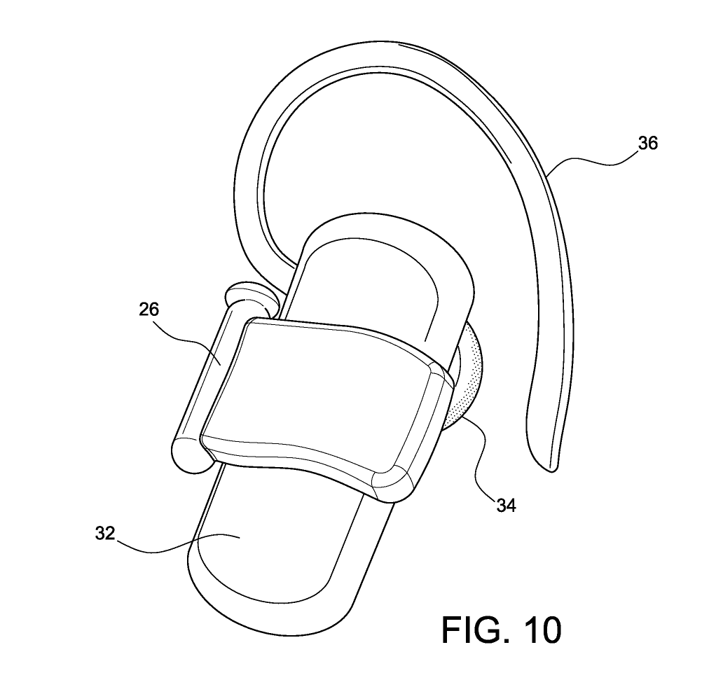

FIG. 9 shows one embodiment of the present accessory 2 attached to a heads-free telephone headset 30, such as a wireless mobile phone headset (Bluetooth®), in accordance with the present disclosure. Generally, a heads-free telephone headset 30 will have a headset body 32, an earbud 34, and an earhook 36. The headset body 32 has a front surface and a back surface, wherein the earbud 34 is attached to the headset body 32 at the back surface. In one embodiment, the accessory 2 is positioned on the headset body 32 such that the first loop 6 and the second loop 8 are disposed on either side of the earbud 34 and the attachment area 4 is disposed on the front surface of the headset body 32 opposite the earbud 34. Since the earbud 34 is frequently not positioned in a central position along the length of the headset body 32, a secure attachment of the accessory 2 to the headset body is enabled by having an accessory 2 with a first loop 6 and second loop 8 as defined herein. By way of example, FIG. 10 shows the flag-shaped decorative item 26 connected to the accessory 2 and detachably secured to the head set body 32 of heads-free telephone headset 30 in accordance with one embodiment of the present invention

Although, the accompanying Figures depict one embodiment of the present invention wherein the first loop 6 is a smaller loop having a small diameter less than the diameter of the second loop 8, or larger loop, it is understood that the first loop 6 and the second loop 8 may be of similar size sufficient to detachably secure the accessory to the hands-free telephone headset

Although the present invention has been disclosed in terms of a preferred embodiment, it will be understood that numerous additional modifications and variations could be made thereto without departing from the scope of the invention as defined by the following claims:

We claim:

1. An accessory for enhancing the aesthetics of a hands-free telephone headset comprising,
an attachment area for receiving a decorative item;
a split loop strap having a first loop and a second loop integral connected with said attachment area;
wherein said first loop and said second loop are of a sufficient size to be coupled around the hands-free telephone headset to detachably secure the accessory to the hands-free telephone headset.

2. The accessory of claim 1, wherein said first loop and said second loop are positioned side-by-side to one another in a plane substantially transverse to a plane of the attachment area.

3. The accessory of claim 1, wherein said first loop and said second loop each have a diameter that is less than one inch.

4. The accessory of claim 3, wherein said first loop has a small diameter that is less than 0.5 inch and said second loop has a large diameter that is less than 0.7 inch.

5. The accessory of claim 1, wherein said decorative item is permanently affixed to said attachment area.

6. The accessory of claim 1, wherein said decorative item is removably attached to said attachment area.

7. The accessory of claim 6, wherein said attachment area further includes a socket and said decorative item includes a corresponding post capable of being received in said socket.

8. The accessory of claim 6, wherein said decorative item is attached to said attachment area using an attachment mechanism.

9. The accessory of claim 8, wherein said attachment mechanism is at least one mechanism selected from the group consisting of hook-and-loop fasteners, posts, pins, adhesives, magnetic tape, two-sided tape, and combinations thereof.

10. The accessory of claim 1, wherein said attachment area and said split loop strap are fabricated from a flexible material.

11. The accessory of claim 10, wherein said flexible material is injection molded vulcanized natural polyisoprene rubber.

12. The accessory of claim 1, wherein said decorative item is fabricated from a material selected from the group consisting of vinyl material, plush material, fabric, molded plastic, metal, and wood.

13. The accessory of claim 12, wherein said rigid material is polycarbonate.

14. The accessory of claim 1, wherein said first loop has a small diameter and said second loop has a large diameter such that said small diameter is less than said large diameter.

15. The combination of a hands-free telephone headset and an accessory comprising,
a) an accessory including,
i) an attachment area for receiving a decorative item; and
ii) a split loop strap having a first loop and a second loop integral connected with said attachment area;
iii) wherein said first loop and said second loop are of a sufficient size to be coupled around the hands-free telephone headset to detachably secure the accessory to the hands-free telephone headset; and
b) a hands-free telephone headset including,
i) a headset body having a front surface and a back surface; and
ii) an earbud attached to said headset body at said back surface;
wherein said accessory is attached to said hands-free telephone headset by disposing said first loop and said second loop around said headset body.

16. The combination of claim 15, wherein said first loop and said second loop are disposed on either side of said earbud with said attachment area disposed on the front surface of the headset body.

17. The combination of claim 15, wherein said first loop and said second loop are positioned side-by-side to one another in a plane substantially transverse to a plane of the attachment area.

18. The combination of claim 15, wherein said first loop and said second loop each have a diameter that is less than one inch.

19. The combination of claim 18, wherein said first loop has a small diameter that is less than 0.5 inch and said second loop has a large diameter that is less than 0.7 inch.

20. The combination of claim 15, wherein said decorative item is permanently affixed to said attachment area.

21. The combination of claim 15, wherein said decorative item is removably attached to said attachment area.

22. The combination of claim 15, wherein said first loop has a small diameter and said second loop has a large diameter such that said small diameter is less than said large diameter.
